(19) United States
(12) Patent Application Publication
(10) Pub. No.: US 2007/0199942 A1
(43) Pub. Date: Aug. 30, 2007

(54) Non-stick paint tray

(76) Inventors: Jason M. Thom, Milwaukee, WI (US); Jay Z. Muchin, Manitowoc, WI (US); David J. Merten, Manitowoc, WI (US)

Correspondence Address: TAFT, STETTINIUS & HOLLISTER LLP, SUITE 1800, 425 WALNUT STREET, CINCINNATI, OH, 45202-3957, US

(21) Appl. No.: 11/361,328

(22) Filed: Feb. 24, 2006

(51) Int. Cl. B05C 21/00

(52) U.S. Cl. 220/570

(57) ABSTRACT

A paint tray, for use in painting with a paint roller and/or paint brush having a non-stick coating applied thereto to improve the cleanability thereof.

### FIELD OF THE INVENTION

Conventional paint trays, for use with rollers in applying paint to wall surfaces and the like, may be made of any suitable material, such as metal or plastic and are generally roughly rectangular in shape. The tray typically has a depression or well near one end into which the painter pours a supply of paint. The well generally terminates in an inclined surface upon which the painter may roll the paint roller to remove excess paint therefrom.

During periods of non-use of the roller, the painter conventionally places the roller upon the tray with the paint applying portion resting on the inclined surface. Sometimes the paint tray is left out for a long period of time before it is cleaned, resulting in the paint drying and sticking to the tray. Needless to say, washing/cleaning up from such a painting project can be a time consuming and tedious task.

Given the circumstances described above the users of these paint trays sometimes throw out the paint tray rather than attending to the steps necessary to fully clean the tray. Even when it is not thrown out, the paint tray may not be cleaned as fully as desired resulting in contamination to the paint used in the next paint job. For these reasons, it can be seen that it would be desirable to have a solution or an improvement on the prior art that addresses this problem.

One well-known prior art “solution” to this problem is the use of a throw away plastic tray liner which is not as expensive, bulky or heavy as the underlying tray. However, such liners can create undesirable refuse. Furthermore, the liners sometimes are not held in place in the trays securely, thereby causing potential problems with spillage, etc. Needless to say, this is not an ideal situation. Other prior art solutions suggest the use of a smooth and/or non-stick surface for the surface of the paint tray, but do not disclose operative ways of incorporating such surfaces, particularly surfaces including a fluoropolymer-type non-stick coating, into a paint tray.

### SUMMARY OF THE INVENTION

The invention herein relates to a paint tray for use for dispensing paint to a roller and/or brush for application to a surface being painted which may be simply and easily cleaned for reuse, which aids in the picking up of the paint from the tray as well as which allows more paint to be removed from the tray resulting in less waste and less paint that ultimately needs to be cleaned up. In particular, the present invention comprises a paint tray having an inclined surface, a well, and side walls for holding paint in the tray that are coated with a non-stick coating, and in particular, a fluoropolymer-type non-stick coating. Non-limiting examples of non-stick fluoropolymer resins or inorganic dry lubricants in accordance with the present invention include but are not limited to solutions comprising polytetrafluoroethylene (PTFE), fluorinated ethylenepropylene (FEP), polyvinylidene fluoride (PVDF), perfluoroalkoxy (PFA), ethylene chlorotrifluoroethylene (ECTFE); molybdenum disulfide (MoS2), and blends thereof. Many of these coatings are available commercially under the Teflon® trademark. The non-stick solutions can further comprise conventionally known film-formers to produce composite non-stick coatings of superior performance. These coatings may be applied to conventional stamped metal paint trays, made of aluminum or steel, as is known in the art. The coating may be applied via spraying, dipping or any other method as is known to those of ordinary skill in the art. Preferably the coating is baked on the tray in order to improve the adhesion thereof.

Additionally within the scope of the invention is the use of a plastic for the tray substrate having a non-stick material, such as a fluoropolymer, impregnated therein. The plastic may be injection molded, thermoformed, vacuumformed, or formed in any other method known in the art into the desired paint tray shape. Additionally, plastics could be used that have the non-stick coating applied to the plastic after the plastic is formed into the desired paint tray shape. Also within the scope of the invention is the use of a plastic or metal sheet having a non-stick coating, such as a fluoropolymer, applied to a sheet prior to stamping the sheet into the desired paint tray shape.

These and other objects will become apparent from the foregoing and ongoing specification, the drawings, and the appended claims.

### BRIEF DESCRIPTION OF DRAWINGS

In the drawings, wherein like reference numerals identify corresponding parts:

FIG. 1 is a perspective illustration of a paint tray and a paint roller according to the principles of the present invention;

FIG. 2 is a side elevation of the paint tray of FIG. 1;

FIG. 3 is a perspective illustration of a leg attached to an underside of a paint tray using a method in accordance with the present invention;

FIG. 4 is a perspective illustration of the attachment portion of a leg as seen from the top side of a paint tray in accordance with the present invention; and

FIG. 5 is a perspective illustration of paint being removed from a paint tray in accordance with the present invention.

### DETAILED DESCRIPTION OF THE INVENTION

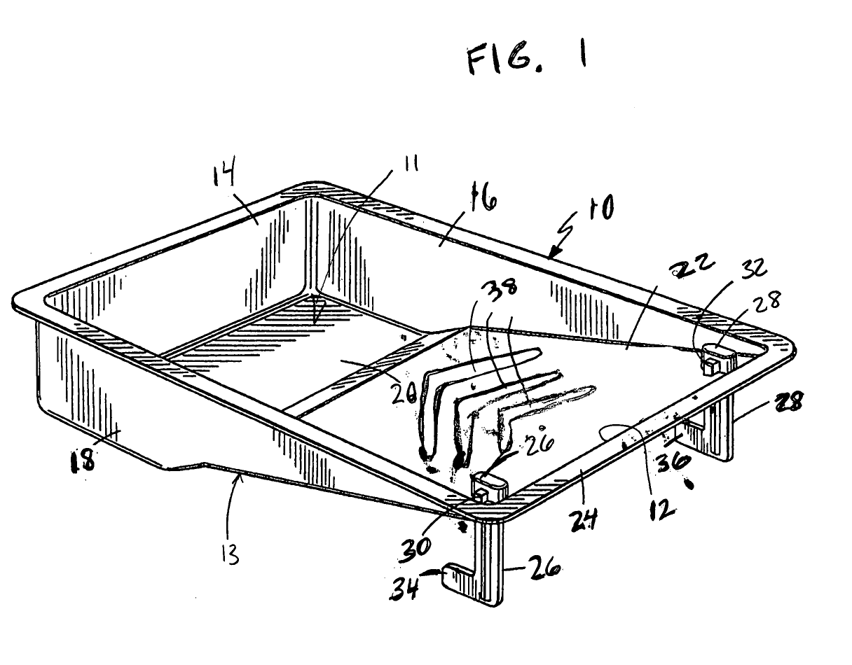

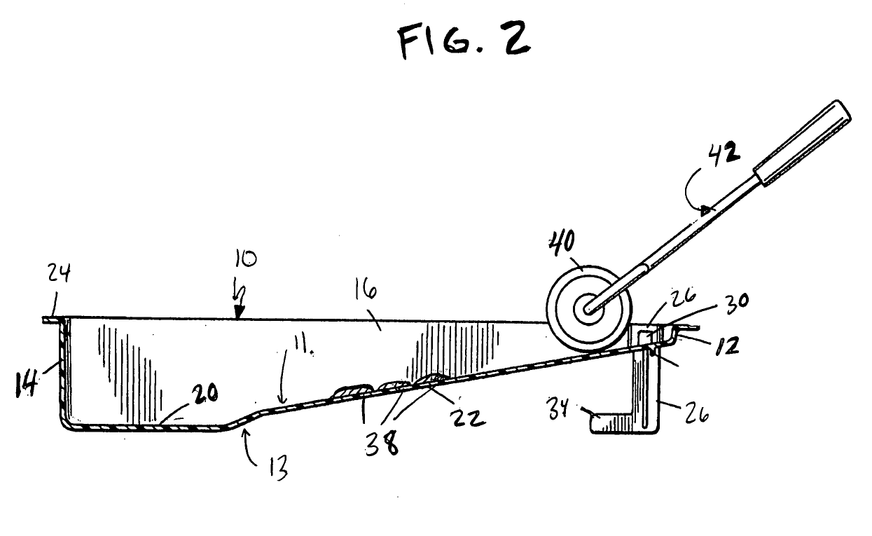

FIGS. 1 and 2 illustrate a conventional paint tray 10 in accordance with the present invention having a top surface 11, a bottom surface 13, a front edge or surface 12 and a rear edge or surface 14, which may be substantially coplanar, having side walls 16, 18. The tray includes a well portion 20 positioned adjacent to and below the rear surface 14 for the storage of paint or the like and an inclined surface 22 tapering upward from the paint well 20 to the front surface 12.

The paint tray 10 may include a peripheral outwardly extending, lateral flange 24. The tray 10 may include a pair of legs 26, 28 extending upwardly inside the shallow end of the tray 10. Both legs 26, 28 may be constructed to be identical for simplicity and ease of manufacture if desired. Each leg 26, 28 may include an upper pin or plug portion 30, 32 for keeping the legs 26, 28 in the tray 10 and may include feet 34, 36 to help keep the tray 10 standing upright or to latch onto a paint holder tray on a ladder. The inclined portion 22 of the tray 10 preferably includes protrusions 38 to help distribute paint on the roller cover 40 of the roller 42. Additionally, the non-stick coating may be applied to: all of the components of the tray 10; only the components that are designed to contact the paint such as the front edge 12, rear edge 14, side walls 16, 18, well 20, and inclined surface 22; only the top surface 11 of the tray 10; or any combination of these components.

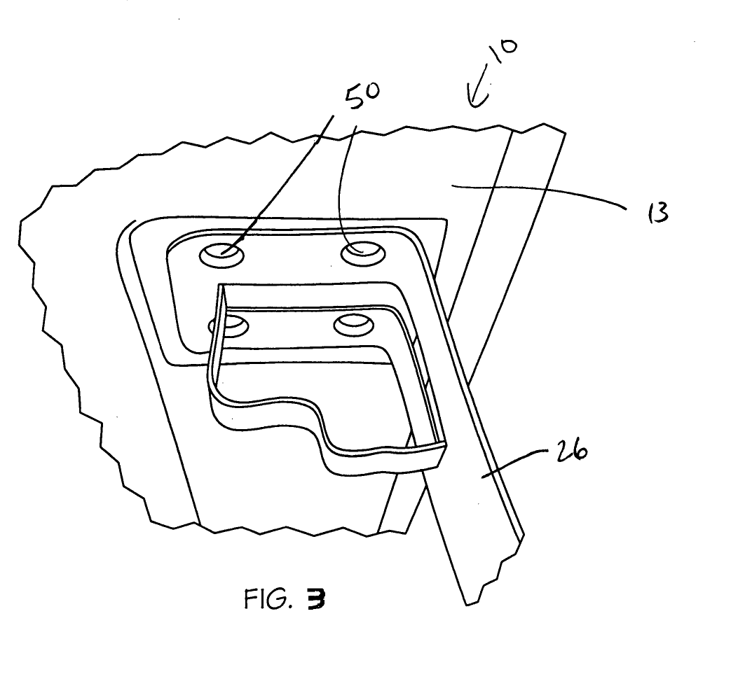

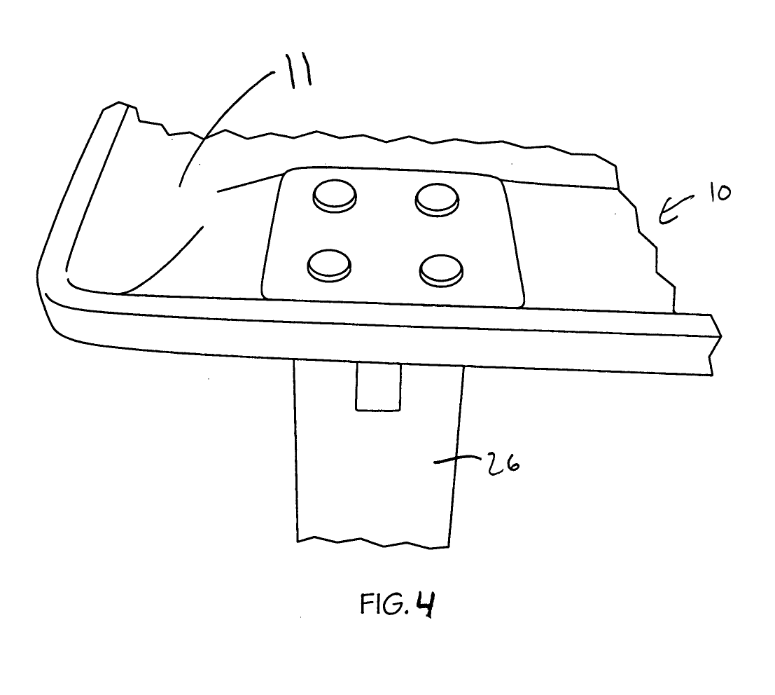

Of course, the invention contemplates that various modifications and changes may be made to the construction of the tray 10. For example, the legs 26, 28 may be stamped or heat-staked to the bottom of the tray 10, or the tray 10 may be formed in a manner where such legs are unnecessary altogether. One embodiment contemplated by the invention, as shown more fully in FIGS. 3 and 4, includes attaching the legs 26, 28 to the bottom surface 13 of the paint tray 10 by “toggling” (or pressing) the legs 26, 28 mechanically thereto. This method is particularly advantageous when the legs 26, 28 are added after the non-stick coating has been applied to the paint tray 10. This is because the toggling method does not require the use of heat or flame that are required by the heat staking or welding methods that might damage the non-stick coating. Additionally, as opposed to using legs that protrude through the top surface 11 of the tray 10 (as shown in FIGS. 1 and 2), the toggling method does not require that a hole or slot be cut in the top surface 11 of the tray 10, thereby preventing damage of the non-stick coating. Using the toggling method, the legs 26, 28 are provided with protrusions 50 thereon. The legs 26, 28 are then mechanically pressed into the bottom surface 13 of the tray 10 creating a mechanical bond between the legs 26, 28 and the bottom surface 13 of the tray 10.

As mentioned above, any non-stick coating as known in the art may be used and are considered operative in connection with the present invention. In particular, fluoropolymer-type coatings are considered operative and within the scope of the present invention. Non-limiting examples of these materials include polytetrafluoroethylene (PTFE), fluorinated ethylenepropylene (FEP), polyvinylidene fluoride (PVDF), perfluoroalkoxy (PFA), ethylene chlorotrifluoroethylene (ECTFE), molybdenum disulfide (MoS2), and blends thereof including organic and inorganic binders that may be added thereto. Specifically, it has been found that the fluoropolymer coating available from Dupont under the tradename Teflon® has been operable and may be used in accordance with the present invention. More specifically, it has been found that the Teflon® Xtra 2 Coat Coil System for Bakeware (Primer—420-15501, Topcoat 420-15803) has been operable and effective in accordance with the invention. In that system, a two part system is used including a primer product that is first applied to the substrate which is followed by the application of the non-stick coating itself. With respect to the paint tray material, any suitable material may be used. Non-limiting examples of operable materials include plastics, tin free steel, stainless steel, aluminum, etc.

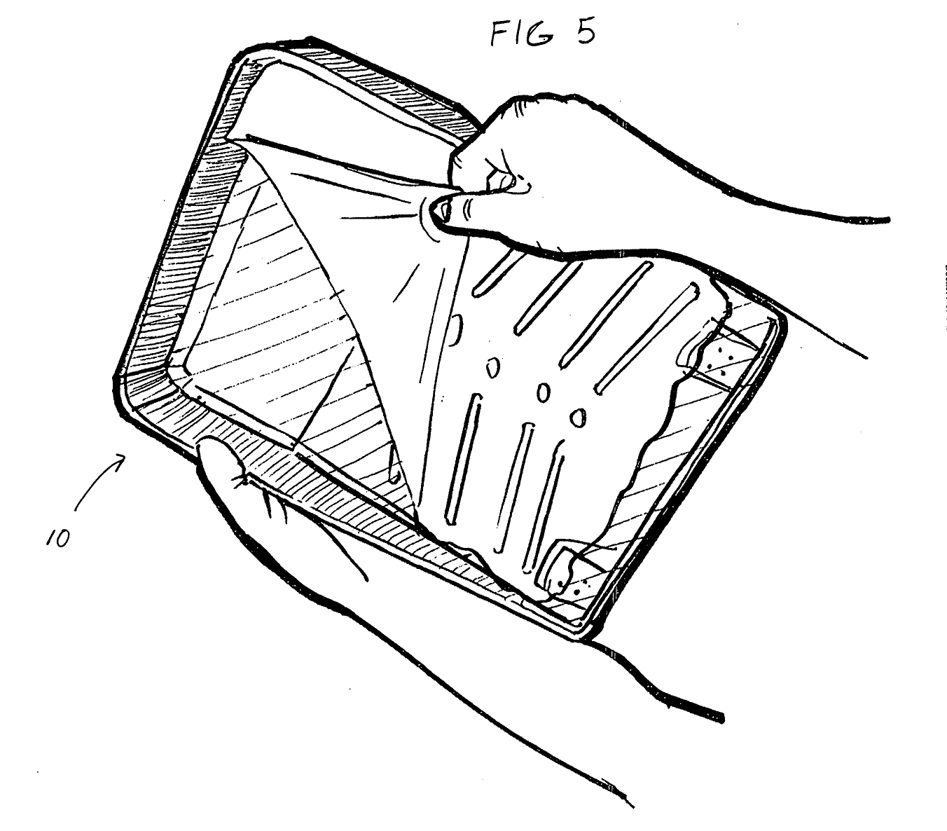

It has been found that the use of such coatings as described herein has made clean up of a paint tray 10 coated therewith much easier. Ease of clean-up testing has shown that paint trays 10 coated in a non-stick coating in accordance with the present invention outperform non-coated trays, particularly when the paint being used is a latex paint. In some cases, it has been unnecessary to use any water or other solvent to clean the tray if the paint is allowed to dry completely. As best shown in FIG. 5, in these conditions, the paint 52 may be easily and simply “peeled” right out of the tray 10. This is in stark contrast to prior art, non-coated trays, where the paint 52 needed to be scraped out of the tray (generally with minimal success). Testing has also shown that the non-stick coatings applied in accordance with the invention have not been degraded significantly by clean-up procedures using solvents, including water and/or mineral spirits, in the instances when such solvents are necessary and/or desirable.

Non-limiting examples of operative methods for preparing a substrate for application of a non-stick coating thereto for use as a paint tray 10 in accordance with the present invention are as follows. Preferably the substrate (metal or plastic) to be coated is cleaned using normal industrial practices as is known in the art, such as chemical washes or solvent cleaning and degreasing. After cleaning, the substrate to be coated and used to form the paint tray 10 in accordance with the invention is preferably handled with gloves to prevent fingerprint contamination of the substrate. Preferably, the substrate is preheated to the baking temperature to remove traces of oil and other contaminants, especially when the substrate is porous. In a preferred embodiment, the substrate may be grit blasted to improve adhesion of the coating. Wheel sanding, wire brushing, sanding, directional grinding and chemical etching may also be used.

The following application procedures can be used to apply the non-stick coatings discussed herein in accordance with the present invention. Of course, other application methods as conventionally known in the art also would be operable and are considered within the scope of the invention as well. In particular, standard industrial compressed air spray equipment may be used to spray the non-stick coating on the substrate. Suction, gravity or pressure type spray equipment are also considered operable. Preferably, distance from the gun to the substrate is between approximately 2-14 inches. If the gun is too close, the finish may look rippled and if it is too far, the spray may look dry and rough.

Electrostatic guns or discs are suitable for the application of non-stick coatings in accordance with the invention. The advantages of electrostatic application include better film uniformity and potential savings in material, due to the reduction in overspray. Airless spray and powder coating techniques may also be used in the manner as is known to those of ordinary skill in the art. Furthermore, dip and flow coating techniques, roller coating techniques, and even brush techniques may be useful in certain situations. Depending on the thickness of the coating to be applied, it may be desired to apply multiple coats of the non-stick coating

In a preferred embodiment, the non-stick coating is heat cured to achieve a strong bond with the substrate. Reaching and maintaining proper cure temperatures for a sufficient period of time to sinter, melt flow or set the film helps insure the best coating. For coatings which are primarily PTFE, PFA and FEP fluoropolymers, no film formation may take place below certain minimum temperatures and thus it is important to maintain proper bake times and temperatures in order to get the desired coating performance. For non-stick coatings which contain organic binders in addition to the fluoropolymer resins, there usually is a greater range of possible cure temperatures and times in order to achieve a desired film property. Still, excessive bake times and/or temperatures may degrade the binder, causing discoloration, film embrittlement and/or loss of adhesion.

Any commonly used type of industrial oven, batch or conveyor, may be used for curing fluoropolymer non-stick coatings in accordance with the present invention. This is because fluoropolymer coatings are rarely affected by the combustion products of coal or natural gas. Infrared and convection ovens may also be used effectively. Factors which may affect total bake time include the following: residence time in the oven; heat capacity of the oven; mass and thermal conductivity of the substrate; air circulation; oven air temperature; percent of substrate covered by the non-stick coating; load of work in the oven; weight to surface area ratio, etc.

Following coating, the substrate may be cut into sheets of desired size and shape for pressing into the desired paint tray 10 form. If desired, the edges are preferably curled over to provide added strength and remove any sharp edges.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A paint tray comprising:
a top surface, a bottom surface, a front edge, a rear edge, and a well shaped to receive a paint roller;
a non-stick coating applied to said top surface.

2. The paint tray of claim 1 further comprising an inclined portion having protrusions thereon.

3. The paint tray of claim 2 further comprising at least one leg attached to said paint tray.

4. The paint tray of claim 3 wherein said at least one leg is toggled to the bottom surface of said paint tray.

5. The paint tray of claim 3 wherein said at least one leg is attached through said top surface and are held in place via a pin or plug.

6. The paint tray of claim 1 wherein said non-stick coating includes polytetrafluoroethylene (PTFE) or fluorinated ethylenepropylene (FEP) or polyvinylidene fluoride (PVDF) or perfluoroalkoxy (PFA) or ethylene chlorotrifluoroethylene (ECTFE) or molybdenum disulfide (MoS2).

7. The paint tray of claim 1 further comprising side walls, said side walls terminating in a lateral flange.

8. The paint tray of claim 7 wherein said lateral flange is curled.

9. The paint tray of claim 1 wherein said paint tray is generally rectangular in shape.

10. The paint tray of claim 1 wherein said paint tray is fabricated from a metal.

11. The paint tray of claim 1 wherein said paint tray is fabricated from a plastic.

12. A paint tray comprising:
a top surface, a bottom surface, a front edge, a rear edge, side walls, an inclined portion and a well shaped to receive a paint roller;
said inclined portion including protrusions thereon;
a fluoropolymer non-stick coating applied to said top surface.

13. The paint tray of claim 12 further comprising at least one leg attached to said paint tray.

14. The paint tray of claim 13 wherein said at least one leg is toggled to the bottom surface of said paint tray.

15. The paint tray of claim 13 wherein said at least one leg is attached through said top surface and are held in place via a pin or plug.

16. The paint tray of claim 1 wherein said non-stick coating includes polytetrafluoroethylene (PTFE) or fluorinated ethylenepropylene (FEP) or polyvinylidene fluoride (PVDF) or perfluoroalkoxy (PFA) or ethylene chlorotrifluoroethylene (ECTFE) or molybdenum disulfide (MoS2).

17. The paint tray of claim 12 wherein said side walls terminate in a lateral flange.

18. The paint tray of claim 17 wherein said lateral flange is curled.

19. The paint tray of claim 12 wherein said paint tray is generally rectangular in shape.

20. A paint tray comprising:
a top surface, a bottom surface, a front edge, a rear edge, at least one leg, an inclined portion and a well shaped to receive a paint roller;
said inclined portion including protrusions thereon;
a fluoropolymer non-stick coating applied to said top surface.

21. The paint tray of claim 20 wherein a primer is applied between said top surface and said fluoropolymer non-stick coating.

22. The paint tray of claim 20 wherein said paint tray is fabricated from aluminum or tin free steel.
